(19) United States
(12) Patent Application Publication
(10) Pub. No.: US 2006/0242320 A1
(43) Pub. Date: Oct. 26, 2006

(54) Method and apparatus for polling

(76) Inventors: Paul Nettle, Plano, TX (US); Christopher Walden, Plano, TX (US)

Correspondence Address: VERNON E. WILLIAMS P.C., P.O. BOX 941385, PLANO, TX, 75094, US

(21) Appl. No.: 11/111,420

(22) Filed: Apr. 21, 2005

(51) Int. Cl. G06F 15/16

(52) U.S. Cl. 709/245

(57) ABSTRACT

A method and apparatus for performing polling is presented. Polling servers include the intelligence and as such may control polling clients. What is polled, when it is polled and how it is polled is controlled by the polling server and may be dynamically changed and any time. As such, the polling server may dynamically reconfigure the polling process for a polling client. In one embodiment, the polling server directs and controls the polling client(s) in a manner that effects load-balancing in a network.

### BACKGROUND OF THE INVENTION

### Description of the Related Art

Polling is a term used in many technological areas to describe a process when one device makes an inquiry or communicates with a second device. Typically polling involves one device querying a number of other devices in a defined order. For example, in computer and communications networks, one computer may communicate with another computer or computers to accomplish a number of procedures. Typically the initiating computer (i.e., polling computer) will begin the polling process by communicating with a computer (i.e., polled computer) that receives the poll. The receiving computer will then respond to the poll or communication.

Polling may be used for a number of reasons. For example, polling is often used for troubleshooting in a communications network. One network device will simply communicate with the other network device(s) as a way of determining if all of the network device(s) are operational in the network. Should one device fail to respond to the poll, it may be an indication that the device is not operational.

Polling is used to perform network administrative procedures. In this scenario, one computer is in charge of polling other computers and communicating commands to perform various administrative procedures. For example, administrative procedures, such as backups and various types of updates, may be accomplished using a polling process.

Irrespective of the specific function accomplished during polling, conventional polling systems are typically configured in client-server or master-slave architecture. In each of these scenarios, the polling device (i.e., the device initiating a poll, inquiry, or communication) controls the polling process and the polled device (i.e., the device receiving and responding to the poll, inquiry, or communication) responds to the polling inquiry. The polling device typically has the process intelligence and manages errors during the polling process. The polled devices are often responsive devices although they may have varying levels of sophistication. The procedural logic is typically associated with the polling device. Therefore, the polling device determines, who is polled, how they are polled, and what happens as a result of the poll. In this scenario, the polled device serves as nothing more than a repository of information.

The flaw in this design is obvious; there is a single point of failure. Should the polling device fail, it puts at risk the procedures associated with the poll across the network. Therefore, a number of techniques have been implemented to address the single point of failure issue. Just about all of these techniques involve more complex polling procedures and architectures. For example, implementing a redundant polling device may supplement and avoid the single point of failure, however, as the number of polling devices increase, the complexity of the system increases, which also increases cost, troubleshooting time, etc.

Thus, there is a need for a cost-effective method and apparatus for performing polling in a network. There is a need for a method and apparatus for performing polling in a network that creates redundancy, but minimizes complexity.

### SUMMARY OF THE INVENTION

In accordance with the teachings of the present invention, a method and apparatus is presented for performing polling. In accordance with the teachings of the present invention, clients are defined as polling devices and poll for information in a public or private network. The polled devices (i.e., servers) maintain the intelligence associated with the poll for each client. Therefore, although the polling device (i.e., client) performs the poll (i.e., initial communication or inquiry), the polled device includes the intelligence that controls and instructs the client on the various tasks that the client should perform.

In accordance with the teachings of the present invention, a client performs a first polling process to poll a polling server, the polling server receives the poll based on the clients use of the first polling process, the polling server then changes the polling process and directs or controls the client to perform a second polling process. It should be appreciated that a variety of clients may access the polling server and that the polling server specifically directs and controls each client individually. For example, the polling server may uniquely change the polling process of each client that accesses the polling server or the polling server may group clients and change the polling process associated with groups of clients.

In one embodiment, the clients access polling servers using a process. The process facilitates load balancing in the network. For example, in one embodiment, the clients generate a pseudo-random number and select a polling server based on the pseudo-random number. As such, polling network load is balanced across the network, since clients randomly access available polling servers. In addition, the polling servers may change and direct the random selection of polling servers. Therefore, dynamic real-time load balancing may be attained across the network. Lastly, the polling server may direct and/or control the clients in a way that separates and groups polling servers. For example, the polling server may direct the client to randomly select a polling server from a group of polling servers positioned behind a Virtual Private Network (VPN). As such, the network may be separated into subgroups to accommodate user purposes and then each subgroup may be dynamically load-balanced for polling and data traffic.

A method of polling, comprises the steps of receiving a poll from a client; performing at least one client specific task in response to receiving the poll from the client; and controlling client operations in response to performing the client specific task.

A method of polling comprises the steps of receiving a poll from a plurality of polling clients, each of the plurality of polling clients using a first polling process; performing a tasks associated with each of the plurality of polling clients in response to receiving the poll; and uniquely controlling each of the plurality of polling clients in response to performing the polling tasks.

A method of load balancing in a network, comprises the steps of receiving polling information from a client; directing the client to randomly select a polling data server in response to receiving the polling information; and effecting load-balancing across the network in response to directing the client to randomly select a polling data server.

### BRIEF DESCRIPTION OF THE DRAWINGS

FIG. 1 displays an architecture implemented in accordance with the teachings of the present invention.

FIG. 2 displays a flow diagram detailing a first method of polling implemented in accordance with the teachings of the present invention.

FIG. 3 displays a flow diagram detailing a second method of polling implemented in accordance with the teachings of the present invention.

FIG. 4 displays a flow diagram detailing a third method of polling implemented in accordance with the teachings of the present invention.

FIG. 5 displays a computer architecture implemented in accordance with the teachings of the present invention.

### DETAILED DESCRIPTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In accordance with the teachings of the present invention, client machines poll polling-server machines. When the client machine contacts a specific polling machine, a set of tasks (i.e., methods) is performed. The tasks are the action items or functions associated with the specific client.

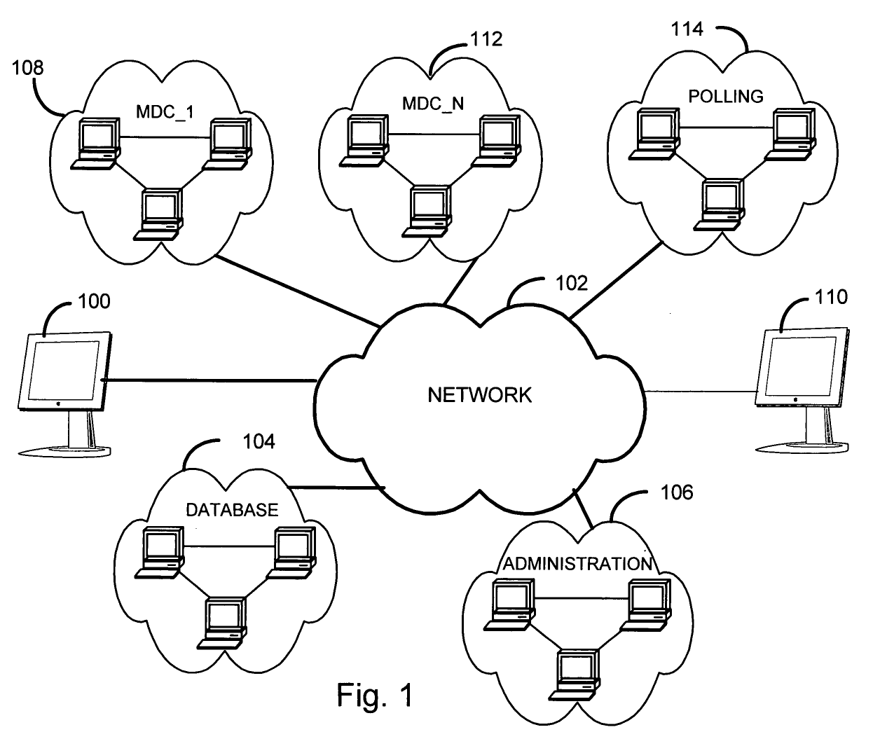

FIG. 1 displays a network architecture implemented in accordance with the teachings of the present invention. An administration client 100 is displayed. An end user operates the administration client 100 to configure the network, provide content to the network, etc. The administration client 100 may be implemented with a variety of technologies, such as a standard computer or as a computer network. The administration client 100 is in communication with a network 102. The network 102 may be a public data network or a private data network. A variety of technologies may be used to implement the network 102, such as packet-switched technology, circuit-switched technology, optical technology, wireless technology, etc.

A database 104 is in communication with the network 102. The database 104 may be implemented as a single database, a distributed database, a database network cluster, etc. The database 104 stores network information about various components of the network shown in FIG. 1. Administration servers 106 are in communication with the network 102. The administration servers 106 include computers in the network used to administer the network 102. The administration servers 106 may include a single database, a distributed database, a database network cluster, etc. Media data centers 108 and 112 are also in communication with the network 102. The media data center (MDC_1) 108 and the media data center (MDC_N) 112 may each represent a plurality of media data centers. The media data centers (108, 112) may be implemented as a database for storing information, storage media, a network cluster of databases, a network cluster or storage media.

Polling (i.e., requesting) clients 110 are shown in communication with the network 102. Polling clients 110 include those clients that an end user operates to request content from the network 102 and/or poll the network 102. Polling servers 114 are in communication with network 102. The polling servers 114 may be implemented with hardware and/or software as a single database, multiple databases, single computer, network computers, etc. In one embodiment, the polling servers 114 receive polls from the polling clients 110 and respond to the polling clients 110. It should be appreciated that while one polling server 114 is shown, polling servers 114 represent multiple polling servers.

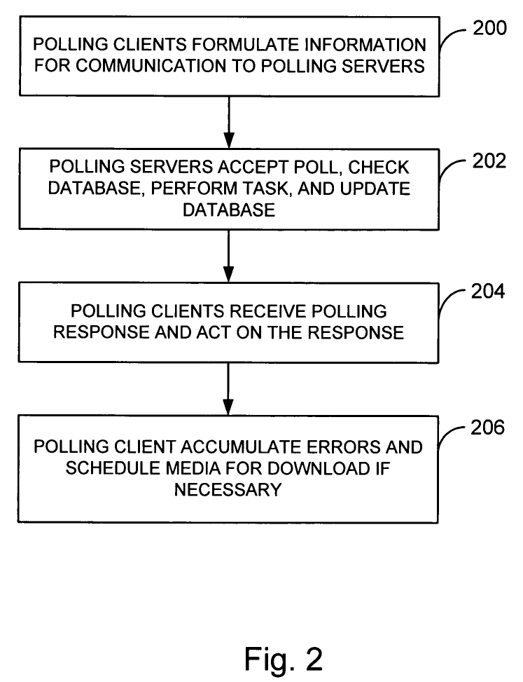

FIG. 2 displays a flow diagram detailing a first method of polling implemented in accordance with the teachings of the present invention. FIG. 2 will be discussed in conjunction with FIG. 1. At step 200, polling clients 110 format polling packets that contain information that needs to be sent to polling servers 114. In one embodiment, this information is sent in a web request.

A variety of different types of information is sent with a poll from the polling clients 110 to the polling servers 114. Among the different types of information are: 1) the polling clients' 110 identification (ID), which may be in the form of an email address or may be a uniquely generated ID (i.e., 093b11e8-1dc4-4720-994f-ba90154dfdf2); 2) a list of companies that the polling clients 110 are associated with; 3) the current IP address of the polling clients 110; 4) a set of bit flags that tell the polling servers 114 how the polling clients 110 are connected to the Internet (through a LAN, Modem, etc.); 5) any “view events” that have taken place since the last poll (i.e., in one embodiment, “view events” represent the content a user operating the polling clients 110 has viewed, and which sub-sections within that content the polling clients 110 have viewed, along with the viewing duration for each subsection and a total time spent viewing the content); 6) flags that specify whether or not host software is currently installed, and if so, if it is currently running. In one embodiment, the software operating on the polling clients 110 includes: host software (i.e., which provides a user interface for the user to select and view content) and a networking component, which handles polling the polling servers 114, downloading content, executing poll commands, etc; and 7) version information for both, the host software and the networking component.

In one embodiment, during polling, a web request (i.e., from polling clients 110) and response (i.e., from the polling server 114) is generated. For example, consider a web request:

http://www.google.com/search.cgi?q=foo&flaqs=1234;

and a response to such a request would be a web page:

<html>

<head>

<title>Google web page</title>

</head>
<body>
...........

In one embodiment, a poll is implemented as a web request, for example:
http://poll01.matcast.neVpoll.cgi?clientID=093b11e8-1dc4-4720-994f-ba90154dfdf2&company=ahalaa&lp=8497690
and, the response to this request may be the following:

p 24000

#

In one embodiment, the response is not an HTML document, but rather a series of commands. In our example, the “p 24000” is a specific response to the client to set the poll time to 24000 seconds (6.666 hours). The hash symbol is used to denote the end of the list of commands.

At 202, the polling servers 114 accept these polls from polling clients 110, and examine the client's record in the database 104. In accordance with the teachings of the present invention, based on what the polling servers 114 retrieve from the database 104 (i.e., the unique instructions associated with the client), the polling servers 114 decide (i.e., the “logical component of the polling servers” 114) the tasks that will be performed for and by the polling clients 110 and which commands need to be sent to the polling clients 110. In other words, the polling servers 114 operate to control the polling clients 110. For example, the polling servers 114 send a response to the polling clients 110. In one embodiment, a poll response is a set of commands (i.e., commands followed by an optional command parameters).

In accordance with the teachings of the present invention, the polling clients 110 poll the polling servers 114. The polling servers 114 perform tasks (i.e., methods) that are specifically tailored for that polling client 110. As mentioned previously, the polling servers 114 receive specific identifying information and/or instructions from the polling clients 110. In response, the polling servers 114 may decide to do one or more of four fundamental tasks: 1) accept polls from new polling clients 110 and add them to the database 104; 2) send the polling clients 110 media packets (i.e., where to get new media); 3) manage “other activities” for that polling client 110; 4) update the database 104 with the most recent polling clients 110 activity information. Each of these categories of tasks is an independent process that may be implemented with a variety of technologies, such as active server pages.

One of the four fundamental tasks is accepting polls from the new polling clients 110 and adding them to the database 104. New polling clients 110 are recognized since their ID does not already exist in the database 104. As such, their polling information is used to create a new record in the database 104 for the polling clients 110. The database 104 stores a moderate amount of information about each polling client 110, including, but not limited to:
1. the user agent used during the poll;
2. the current version information for both, the host software and the networking component;
3. the first and last poll time (timestamp format);
4. the IP address that the polling clients 110 used during the last poll;
5. the media (i.e., content) scheduled to be delivered to the client;
6. the list of media that has already been sent to the client;
7. the client ID;
8. the companies that a client is associated with (American Airlines, etc.);
9. the client's connection type (i.e., LAN, Modem, etc.);
10. subscription information (if they are subscribed, when it expires, etc.);
11. which video codecs the client is scheduled to receive;
12. the complete set of view events recorded for the client since the last poll;
13. flags specifying whether or not the host software is still installed on the client, and if so, if it was currently running during the last poll;
14. etc.
   For new polling clients 110, the database 104 is populated with a minimal amount of information(i.e., as much of this information is available on the network 102). In one embodiment, only a small amount of this information must be present in the database 104 (i.e., just a client ID and the list of companies that the client is associated with) during operation.

In one embodiment, a special set of tasks is implemented for new polling clients 110. Primarily, the polling clients 110 must be sent the latest video codecs (i.e., drivers that allow you to view various types of audio/video content), so that they can properly view the media and so that they can receive the media. These codecs are special—they are not treated like media content because the client must receive the codecs before it receives any media. However, media is not sent to the client in any particular order. Therefore, the binary data for these codecs is sent to the client as part of the polling response. This is done using an installation command whose parameter is a base64-encoded binary data for an installation package containing the video codecs.

A second task performed by the polling servers 114 includes sending media packets. Sending a client a media packet is another type of response to a poll. It is a set of responses from the polling servers 110. Whether or not media is to be sent to a client (and if so, what media) is determined by querying the database 104.

A third task includes managing activities for the client. Any command that the client should perform may be send from the polling servers 114. In one embodiment, every response to a poll is a command or series of commands. In addition, commands can be sent individually or streamed together. For example, a single poll response could cause the client to receive ten pieces of media, change the client's poll time to thirty minutes, have it install a set of codecs and restart itself, all within in a single poll response. Each poll may be separated into individual polls, but a batch process may also be used.

The final of the four general tasks is updating the database 104 with the most recent client information. This last task is similar to adding new clients except that a record is not created, but instead we simply modify a few existing fields. In one embodiment, these fields include:
1. the time of the last poll;
2. the IP address and user agent used by the client during the last poll;
3. adding any view events sent by the client in the last poll;
4. updating the software version information for our software running on the client;
5. updating the client's connection type (modem, LAN, etc).
   Along with these updates, the polling servers 114 also update the client's record in the database 104 with the latest information detailing what the polling servers 114 have done. For example, if the client is scheduled to receive a piece of content, then once that data has been sent to the client, that piece of content is removed from the database list of content scheduled to be delivered to the client.

As part of the polling process, the client can send back error information. If the client has had difficulty performing any of its tasks installing codecs, downloading media, or even connecting to the polling servers 114, then the errors are accumulated on the client. Every time the client polls, these errors are sent along with the poll and the client purges its current list of errors. The polling servers 114 record these errors in the database 104 for subsequent troubleshooting. The database 104 is then updated.

At step 204, the polling clients 110 receive the polling response from the polling servers 114 and act upon them. In one embodiment, every poll response includes a list of active polling servers 114. The polling clients 110 store this information for future reference. When it comes time for the polling clients 110 to perform a poll, it consults its current list of polling servers 114, and in accordance with the teachings of the present invention, randomly selects one from the list and polls that polling server 114. If the poll fails, the address associated with the failed polling server 114 is removed from the polling clients' 110 local copy of the list and the polling clients 114 select another polling server 114 (i.e., at random) from the list. At step 206, any errors are accumulated for future polls and if media is scheduled, then the polling clients 110 can begin to gradually download the media.

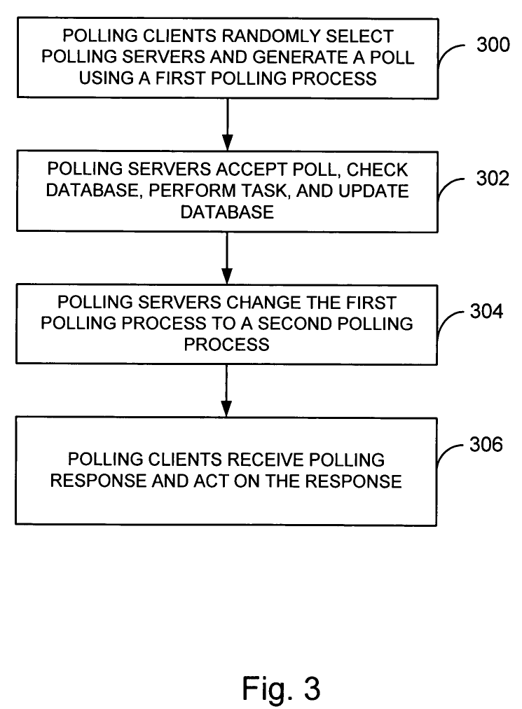

FIG. 3 displays a flow diagram detailing a second method of polling implemented in accordance with the teachings of the present invention. FIG. 3 will be discussed in conjunction with FIG. 1. At step 300, polling clients select polling servers and generate a poll using a first polling process. For example, polling clients 110 select polling servers, such as polling servers 114, and generate a poll to polling servers 114. In accordance with the teachings of the present invention, the polling clients 110 may select the polling servers using a static address provided to the polling clients 110 or the polling clients may use a random method to select polling servers 114. When a static address is provided to the polling clients 110, the polling clients 110 will poll the polling servers 114 identified by the static address. In an alternative embodiment, a plurality of addresses is provided to the polling client 110. When a plurality of addresses is provided to the polling clients 110, the polling clients 110 may use a variety of random methods to select polling servers 114 to poll. As such, polling is distributed across a number of different polling servers 114 and load balancing is accomplished across the network 102. Once again, it should be appreciated that polling clients 110 represent many clients and polling servers 114 represents many polling servers.

In accordance with the teachings of the present invention, the polling clients 110 may be provided with a list of polling servers' addresses and perform a LIFO function to select a polling server 114. In a second embodiment, the polling servers 114 may perform a FIFO function. In a third random method the polling client 110 may associated an index with each address of each polling server 114 and select a polling server 114 based on a pseudo-random number generation technique. For example, in one embodiment, the address is randomly selected by taking the modulus of the output of the pseudo-random number generator with the size of the list. Once again, with a plurality of polling clients 110 each using a random method to select a polling server 114 and randomly polling a polling server 114 based on the random method, load-balanced polling is accomplished across the network 102 shown in FIG. 1.

The foregoing method of polling, in which a static address is provided to the client 110 and a polling server 114 is selected, may be considered a first polling process. In the alternative, the random method used to poll may be considered a first polling process. Further, a variety of alternative methods may be considered a first polling process. For example, polling clients 110 may be given a specific order that should be used to poll polling servers 114. Polling clients 110 may be given directions to poll and then wait for a given time before issuing another poll. Polling clients 110 may be given initial directions to poll several polling servers 114 at the same time and then respond to the first response that is received. It should be appreciated that a variety of different permutations and combinations may be performed.

At 302, the polling servers 114 accept these polls generated by polling clients 110, and examine the polling clients' 110 records in the database 104. In accordance with the teachings of the present invention, based on what the polling servers 114 retrieve from the database 104 (i.e., the unique instructions associated with the polling clients 110), the polling servers 114 decide (i.e., the “logical component of the polling servers” 114) the tasks that will be performed for and by the polling clients 110 and which commands need to be sent to the polling clients 110. In other words, the polling servers 114 operate to control the polling clients 110. For example, the polling servers 114 send a response to the polling clients 110. In one embodiment, a poll response is a set of commands (i.e., commands followed by optional command parameters).

In accordance with the teachings of the present invention, the polling clients 110 poll the polling servers 114. The polling servers 114 perform tasks (i.e., methods) that are specifically tailored for that polling client 110. As mentioned previously, the polling servers 114 receive specific identifying information and/or instructions from the polling clients 110. In response, at 304, the polling servers 114 control and direct the polling clients 110 and change the first polling process to a second method of operation. The second method of operation may be a second polling process or some other second method of operation. In accordance with the teachings of the present invention, in a scenario where the polling clients 110 poll the polling servers 114 using a first polling process, the polling servers 114 may completely redirect the polling clients 110 to perform a second polling process immediately, on the next poll, or some time later. For example, the polling clients 110 may have a static address for a polling server 114 and just poll the polling server 114 the first time that the polling clients 110 poll the network 102. The static method of polling would be the first polling process. The polling servers 114 may then provide the polling clients 110 with a list of addresses associated with polling servers 114. The polling clients 110 may then use a random method of selecting a polling server 114 and a) immediately, randomly select a second polling server 114 and perform a poll, b) randomly select a polling server 114 at some time later and performing a poll, and/or c) randomly selecting a polling server 114 and on the next scheduled poll of the polling server 114, performing a poll using the randomly selected polling server 114. The method of randomly selecting a polling server 114 is a change to the first polling process (i.e., statically selecting a polling server 114). As such, the random method of polling is a second polling process.

In one embodiment, the polling servers 114 provide the polling clients 110 with several addresses of polling servers 114 and direct the polling clients 110 to randomly select a polling server 114. The list of addresses in combination with the directions to randomly select addresses from the list for polling enables the polling servers 114 to control load balancing across the network 102. For example, the polling servers 114 may provide the polling clients 110 with a list of polling servers 114 located in a VPN and direct the polling clients 110 to randomly select from the list of polling servers 114 in the VPN. As such, load balancing is accomplished across a subset of the polling servers 114 (i.e., poling servers in the VPN) in the network 102. Using this foregoing method, the polling servers 114 may dynamically perform load shifting and load balancing across various parts of the network 102. For example, polling clients 110 may pay for different levels of quality of service (QoS) and the polling clients 110 may load balance the entire network 102 so that polling clients 110 that require the highest levels of QoS use a group of low traffic polling servers 114 and polling clients 110 that require a lower level of QoS use a group of high traffic polling servers 114. Using the foregoing technique, load balancing may be dynamically maintained so that regardless of the varying traffic demands in the network 102, the high level QoS polling clients 110 are always receiving the best service and the lower level QoS polling clients 110 are always receiving a lesser service. Further, using the foregoing methods, load balancing and QoS can be dynamically changed in real-time.

It should be appreciated that a variety of combinations and permutations may be performed in accordance with the teachings of the present invention. For example, the polling clients 110 may poll polling servers 114 in a certain order, time schedule, etc. and then the polling servers 114 may respond changing the order, time schedule, etc. of polling after which, at 306, the polling clients 110 poll polling servers 114 in a different order, time schedule, etc.

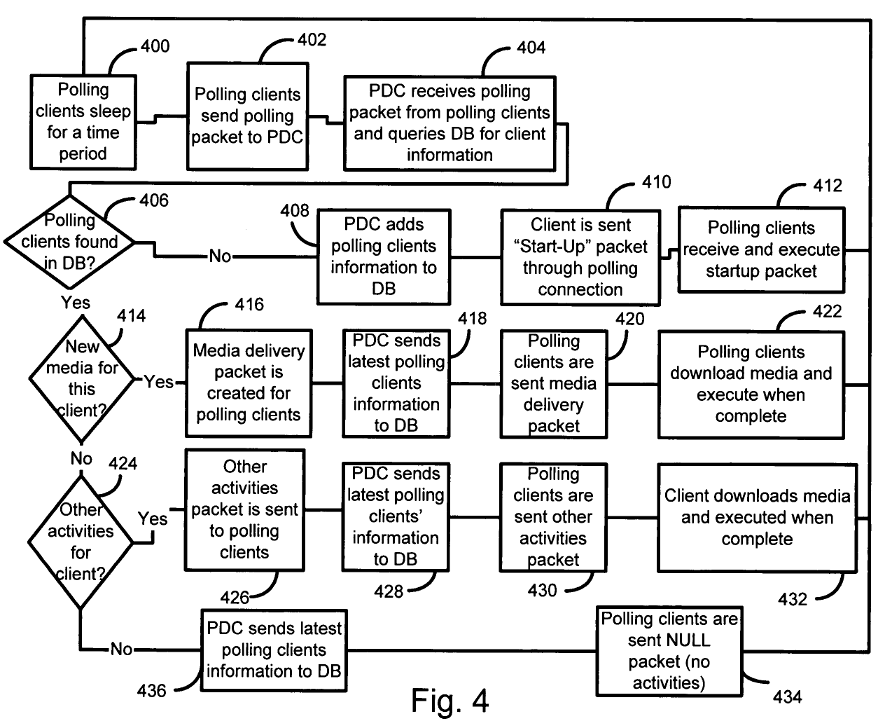

FIG. 4 displays a flow diagram detailing a third method of polling implemented in accordance with the teachings of the present invention. FIG. 4 will be discussed in conjunction with FIG. 1. At 400, the polling clients 110 sleep for a period of time. At step 402, the polling clients 110 send a polling packet to the polling servers 114. At 404, the polling servers 114 receive the poll from the polling clients 110 and query the database 104 for client information. If the polling clients 110 are not found in the database 104, at 408, the polling servers 114 add the polling clients 110 information to the database 104. At 410, the polling clients 110 are sent a start-up packet through a polling connection. At 412, the polling clients 110 receive and execute the start-up packet. At 414, If the polling clients 110 are found in the database (i.e., 406) and new media is available for the polling clients 110, then a media delivery packet is created for the polling clients 110 as stated at 416. At 418, the polling servers 114 send the latest polling clients' 110 information to the database 104. At 420, the polling clients 110 are sent a media delivery packet and at 422, the polling clients download media and execute this process when the download is complete. At 414, if there is no new media for the polling clients 110, but there are other activities for the polling clients 110 (i.e., 424), the other activities packet is sent as stated at 426. At 428, the polling servers 114 send the latest polling clients' 110 information to the database 104. At 430, the polling servers 114 send the other activities packets to the polling clients 110. At 430, the polling clients 110 download media and execute the content when the download is complete (i.e., 432). If there are no other activities for the polling clients 110, the polling servers 114 send the latest polling clients' 110 information to the database 104 as stated at 436 and the polling clients 110 are sent a null packet as stated at 434.

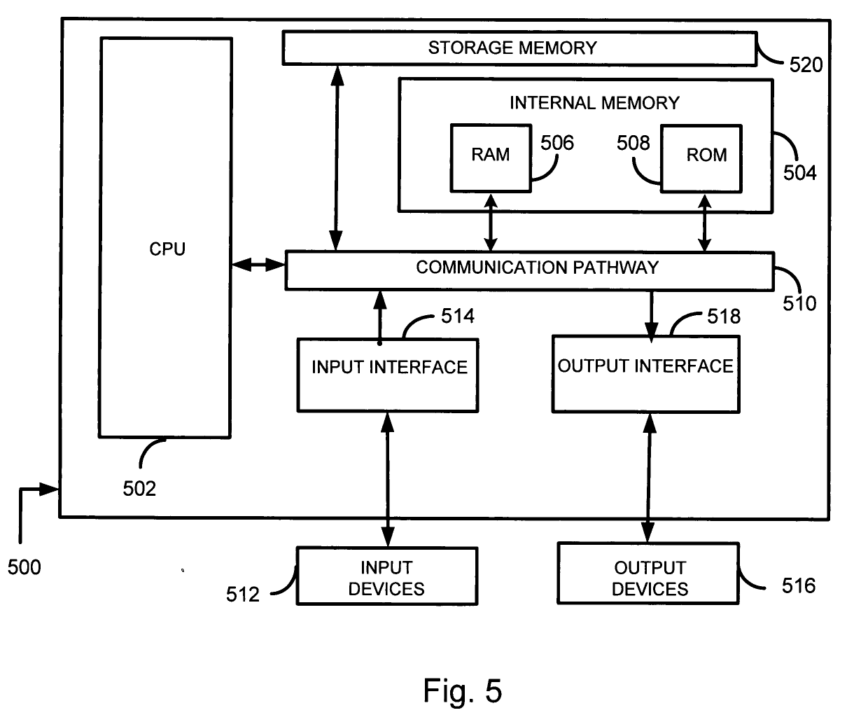

FIG. 5 displays a computer hardware architecture implementing the teachings of the present invention. The computer 500 may be used to implement the client 100, network 102, database 104, administration servers 106, polling servers 114, or a media data center 108, 112, or 114 of FIG. 1. A central processing unit (CPU) 502 functions as the brain of the computer 500. Internal memory 504 is shown. The internal memory 504 includes short-term memory 506 and long-term memory 508. The short-term memory 506 may be a Random Access Memory (RAM) or a memory cache used for staging information. The long-term memory 508 may be a Read Only Memory (ROM) or an alternative form of memory used for storing information. Storage memory 520 may be any memory residing within the computer 500 other than internal memory 504. In one embodiment of the present invention, storage memory 520 is implemented with a hard drive. A communication pathway 510 is used to communicate information within computer 500. In addition, the communication pathway 510 may be connected to interfaces, which communicate information out of the computer 500 or receive information into the computer 500.

Input devices, such as tactile input device, joystick, keyboards, microphone, communications connections, or a mouse, are shown as 512. The input devices 512 interface with computer 500 through an input interface 514. Output devices, such as a monitor, speakers, communications connections, etc., are shown as 516. The output devices 516 communicate with computer 500 through an output interface 518.

Thus, the present invention has been described herein with reference to a particular embodiment for a particular application. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A method of polling, comprising the steps of:
receiving a poll from a client;
performing at least one client specific task in response to receiving the poll from the client; and
controlling client operations in response to performing the client specific task.

2. A method of polling as set forth in claim 1, wherein the step of performing client specific tasks further comprises the step of accepting new polls from new clients.

3. A method of polling as set forth in claim 1, wherein the step of performing client specific tasks further comprises the step of adding new clients to a database.

4. A method of polling as set forth in claim 1, wherein the step of performing client specific tasks further comprises the step of updating a database with the clients' most recent activity.

5. A method of polling as set forth in claim 1, wherein the step of performing client specific tasks further comprises the step of communicating with the client on where to retrieve content.

6. A method of polling as set forth in claim 1, wherein the client specific task includes changing a polling process associated with the client.

7. A method of polling as set forth in claim 1, wherein the step of controlling client operations include organizing the client into a group of clients.

8. A method of polling as set forth in claim 1, wherein the step of controlling client operations includes controlling client polling operations to effect load-balancing across a network.

9. A method of polling as set forth in claim 1, wherein the poll is associated with a first polling process; and the client operations includes a second polling process different from the first polling process

10. A method of polling as set forth in claim 1, wherein the client specific task includes accessing a database across the network for specific instructions associated with the polling client.

11. A method of polling as set forth in claim 1, wherein the client specific task includes receiving download information identifying that a media center that has downloadable content for the client.

12. A method of polling as set forth in claim 1, wherein the client specific task includes providing the client with a list of polling servers available to the client and the step of controlling client operations comprises the step of instructing the client to select a polling server from the list of polling servers.

13. A method of polling comprising the steps of:
receiving a poll from a plurality of polling clients, each of the plurality of polling clients using a first polling process;
performing a tasks associated with each of the plurality of polling clients in response to receiving the poll; and
uniquely controlling each of the plurality of polling clients in response to performing the polling tasks.

14. A method of polling as set forth in claim 13, wherein the step of uniquely controlling each of the plurality of polling clients includes the step of directing at least of the clients to perform a second polling process unique to each of the plurality of clients.

15. A method of polling as set forth in claim 13, wherein the task associated with each of the plurality of clients includes providing each of the plurality of clients with a list of available polling servers.

16. A method of polling as set forth in claim 13, wherein the step of controlling client operations comprises the step of instructing each of the plurality of clients to randomly select a polling server from the list of polling servers.

17. A method of polling as set forth in claim 13, further comprising the step of load-balancing the polls across a network in response to the step of instructing each of the plurality of clients to randomly select a polling server from the list of polling servers.

18. A method of polling as set forth in claim 13, wherein the poll is associated with a first polling process; uniquely controlling each of the plurality of polling clients includes a second polling process different from the first polling process

19. A method of load balancing in a network, comprising the steps of:
receiving polling information from a client;
directing the client to randomly select a polling data server in response to receiving the polling information; and
effecting load-balancing across the network in response to directing the client to randomly select a polling data server.

20. A method of load balancing as set forth in claim 19, wherein the step of randomly selecting a polling data server further comprises the step of receiving a list of polling data servers in response to receiving the polling information; proving the list to the client and directing the client to randomly select a polling data center from the list of polling data servers.
